(19) United States
(12) Patent Application Publication
(10) Pub. No.: US 2025/0095013 A1
(43) Pub. Date: Mar. 20, 2025

(54) SYSTEM AND METHOD OF SUCCESSION PLANNING FOR PRIVATELY HELD SMALL BUSINESSES

(71) Applicants: Deepa Krishnamurthy, Tiverton, RI (US); William J. Beckeman, Tiverton, RI (US)

(72) Inventors: Deepa Krishnamurthy, Tiverton, RI (US); William J. Beckeman, Tiverton, RI (US)

(21) Appl. No.: 18/752,773

(22) Filed: Jun. 24, 2024

Related U.S. Application Data
(60) Provisional application No. 63/522,549, filed on Jun. 22, 2023.

(51) Int. Cl. G06Q 30/0201

(52) U.S. Cl. CPC G06Q 30/0206

(57) ABSTRACT

Disclosed is a digital marketplace for the valuation and sale of privately owned small businesses using methodology and a valuation tool designed to engage market participants in the value estimating process. Other embodiments include the compilation, vetting and organization of a variety of salient individual small business information from publicly available sources and the validation of such information by small business owners enabled by certain privacy and confidentiality protections offered to them. Other embodiments include the ability of registered users to search companies based upon a variety of metrics, including industry/sub-industry, geography/location and company size based upon employment or estimated business enterprise value (determined using a valuation methodology and estimating tool). Further embodiments include the compilation, creation, vetting and organization of various digital resources, and introductions to human/company resources, to assist market participants throughout the sale process from succession planning to post-closing obligations.

### CROSS-REFERENCE TO RELATED APPLICATIONS

Priority is claimed on Provisional Patent Application No. 63/522,549 filed Jun. 22, 2023, the contents of which are incorporated herein by reference in its entirety.

### TECHNICAL FIELD

This disclosure relates generally to the technical field of generating evaluations of privately held businesses and, more particularly, to a method and system for evaluating performance of a business through an online platform marketplace to aid in purchase and sale of and succession planning for privately held small businesses.

### BACKGROUND

With the open data available to prospective buyers, marketing and valuing publicly held companies is a well-honed. Conversely, privately held companies often maintain their business data in secret, making valuation and sale price convergence between a prospective buyer and seller more difficult. The sheer number of small businesses to research, and the difficulty in finding reliable data is not only costly and time-consuming for a prospective buyer, but often fragmented and opaque and, therefore, lacks continuity for comparison between the various privately held small businesses.

Private small business owners often seek to sell their business when the time comes for retirement or new leadership. Too often, such owners are not prepared for the many challenges associated with finding an acceptable buyer. Privacy issues, lack of proactive planning, and the unique nature of individual small businesses are some of the obstacles to overcome.

The US Small Business Administration (“SBA”) Office of Advocacy generally defines a small business as an independent business having fewer than 500 employees. A table of size standards for purposes of government programs and contracting is also published by the SBA. This table lists small business size standards matched to industries described in the North American Industry Classification System (NAICS), as modified by the Office of Management and Budget. FIG. 2 is the SBA table effective Jan. 1, 2022, for manufacturing businesses, including the number of employees and revenue. The SBA also includes the table of size standards in the Small Business Size Regulations, 13 CFR §121.201, which includes size standards that have changed since the last publication of 13 CFR §12.

In 2022 the US SBA also released the following statistics regarding small businesses in the United States: 1. Small businesses account for close to half of all jobs and make up more than 99% of all businesses; 2. There are 33.2 million small businesses that employ 60.7 million people; and 3. Over 5.4 million of these small businesses employ between 1-19 people; 4. Approximately 50% of small businesses with less than 20 employees are owned by people over the age of fifty-five, representing 2.9 million businesses, 32.1 million employees, $1.3 trillion in payroll and $6.5 trillion in revenues.

Additionally, four years of surveys of private businesses by Pepperdine University showed that: 1. nearly 50% of private business owners wished to sell their business in the next five years; 2. nearly 80% of these small private businesses did not plan for succession; 3. nearly two-thirds rely on word-of-mouth referrals; and 4. Surveys by investment banks show that 60%-70% of small business owners that attempt to sell their businesses end up not selling.

Small, local businesses enjoy great public support. However, in recent years private investors as well as government funding have been focused mostly on the ecosystem and support of new start-up businesses. Start-up founders are commonly celebrated for their entrepreneurship while established small business owners often struggle to find investors and buyers when the time comes to sell their businesses. This occurs even though a small business economics study showed that it takes forty-three start-ups to generate one survivor business ten years later, which will create a net of only nine new jobs, while each job created by local small businesses engaged in traded goods and services, e.g., manufacturers and business service providers, creates two additional jobs in the local economy.

Seeking a purchaser to buy an existing business or searching for a business owner who is willing to sell their business is a long and sequential process, full of friction that results in hurdles along the way as illustrated in Prior Art FIG. 1. The small business domain is enormous, and each private business is unique. Information on a private business' value is not available and information on comparable sale transactions that have been executed are typically kept confidential.

Currently, various intermediaries and market participants such as Biz equity, Biz.Buy.Sell, PrivCo, and ZoomInfo, to name a few, attempt to address this varied, vast, and opaque ecosystem by tackling one or more elements of the constraints identified herein. The existing market is ad-hoc, chaotic and the organizations that try to architect solutions do so for problems that arise at different steps of a business sale transaction. The solutions are varied, generally inadequate for all participants, and mostly sub-optimal for private small business owners. This leads to varying degrees of success, and buyers and sellers end up finding each other in often serendipitous, usually inefficient, sub-optimal or circuitous ways, or not at all, as also illustrated in FIG. 1. Comprehensive solutions are lacking.

### SUMMARY OF THE DISCLOSURE

There is a need for greater public attention being placed on established local businesses and a different breed of entrepreneurs who are dedicated to buying, running, and growing these established small businesses.

Because private business owners often do not disclose data and other information about many of the attributes a potential buyer wants to know before initiating a purchase evaluation, including financial and key non-financial information, the overall market is hard to evaluate and comparisons between privately held small businesses are extremely difficult, even when they are in similar fields. This lack of transparency and availability of key information about private small businesses in a consistent manner results in too few transactions, lost time, and depressed sale prices. This is a problem across all privately held small business industries.

A market is well-functioning when the participants-private small business owners and potential buyers, can easily seek out and transact in the sale/purchase of a small business while maximizing each of their economic and other objectives. A market may be considered non-functioning or failing when it does not allow for a seamless seeking and discovery of the participants that can then lead to a mutually optimal transaction. A functioning, efficient marketplace for the sale of private small businesses currently does not exist.

To that end, illustrative embodiments of the present disclosure provide a system and method to support the purchase and sale of privately owned small businesses by utilizing a digital platform marketplace. This digital platform addresses a main causes of market failure: fragmentation due to the vast and varied nature of both the small businesses, and their support ecosystem and poor information visibility due to privacy constraints. The privacy constraints are two-fold: the privacy of selling intentions due to the business owner's fears of adverse business impacts resulting from disclosure; and the privacy of company financial information and other business attributes which have no public reporting requirements. These constraints make estimating the values of private small businesses exceedingly difficult, and result in the lack of a starting point for a pricing guidance for market participants.

The present disclosure brings together market participants in a functioning marketplace focused on the needs and concerns of the private small business owner. To that end, illustrative embodiments of a marketplace according to the present disclosure may include a “hard” digital infrastructure component and a “soft” data and information component.

The hard infrastructure may include a digital, i.e., online, platform marketplace that houses the market participants that allows them to interact with each other in a secure, private, and confidential manner. The soft data and information component includes a suite of information including processing, transaction tracking and communication management tools, and a set of rules for use by market participants to engage securely, privately, and confidentially in the market activities including, among other things, searching, planning, and communicating. The information processing tool notably includes a business valuation estimating tool and methodology that enables consistent and comprehensive pricing guidance to market participants. In various embodiments, the digital marketplace platform may include three groups of participants, for example private, 1. small business owners, 2. potential buyers and/or investors, as well as 3. advisors and other service providers.

Private small business owners: namely, in some embodiments, owners of businesses that are defined as small under the size guidelines from the US SBA. Generally, size guidelines vary by industry/sub-industry, may be reset annually, and could be based on revenues, number of employees or assets owned. A vast majority of businesses are likely to have less than $5 million in annual revenues and/or have less than twenty employees. This market will initially include a profile of some or all private businesses in some or all industries that are registered to do business in a desired region, such as within their city, county, state, region, or country. Over time, with improved gathering of annual revenue and company size data, the list may be culled to only include private businesses defined as small under the US SBA guidelines. In one embodiment, officers of the business identified as such on their Secretary of State filings may register as a private business owner market participant. For example, in one exemplary embodiment one sub-market may focus exclusively on the manufacturing industry, covering all businesses categorized under NAICS group 31, 32, 33. The first phase of this example disclosed herein includes manufacturing companies in the exemplary state of Rhode Island.

Potential Buyers and Investors: This group includes registered participants that join the platform after being qualified based on certain criteria. These criteria may include certain accreditation, financial resources, and/or registration requirements, among others.

Advisors and Service Providers: These are registered participants that are qualified by certain accreditation or registration criteria for their area of expertise. They may agree to provide support services such as legal and documentation, valuation, accounting, deal negotiation, succession planning, lending, and financing, and execution formalities, to name a few. These may be offered as standard services, at periodically negotiated prices and an acceptable level of quality to help reduce transaction costs. and increase transaction efficiency.

Illustrative embodiments include features that facilitate the design of a functioning marketplace. These features may include a searchable company profile for each small business together with an estimate of enterprise value, a proprietary private small business enterprise value estimating tool, and a privacy-focused communication design or portal.

The aspects of the present disclosure for a marketplace to facilitate the evaluation, sharing of data and information, as well as a system and method to support the purchase and sale of privately owned small businesses may be embodied for example, as a computer system, a method, or a computer program product. Accordingly, various embodiments may take the form of an entirely hardware embodiment, an entirely software embodiment, or an embodiment combining software and hardware aspects. Furthermore, some embodiments may take the form of a computer program product stored on a computer-readable storage medium having computer-readable instructions (e.g., software) embodied in the storage medium. Various embodiments may take the form of web, mobile, wearable computer-implemented, computer software. Any suitable computer-readable storage medium may be utilized including, for example, hard disks. compact disks, DVDs, optical storage devices, and/or magnetic storage devices.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a graphical representation of a prior art method for succession planning and selling journey of a small business owner;

FIG. 2 is a printout of the SBA table of size standards effective Jan. 1, 2022, for manufacturing businesses;

FIG. 3 is a flow chart illustrating the input, application and output estimate for succession planning for privately held businesses in accordance with the present disclosure;

FIG. 4 is a flow chart illustrating the business owner input and creation of model scenarios;

FIG. 5 is a flow chart illustrating buyer matching; and

FIG. 6 is a printout of an exemplary company page according to the present disclosure.

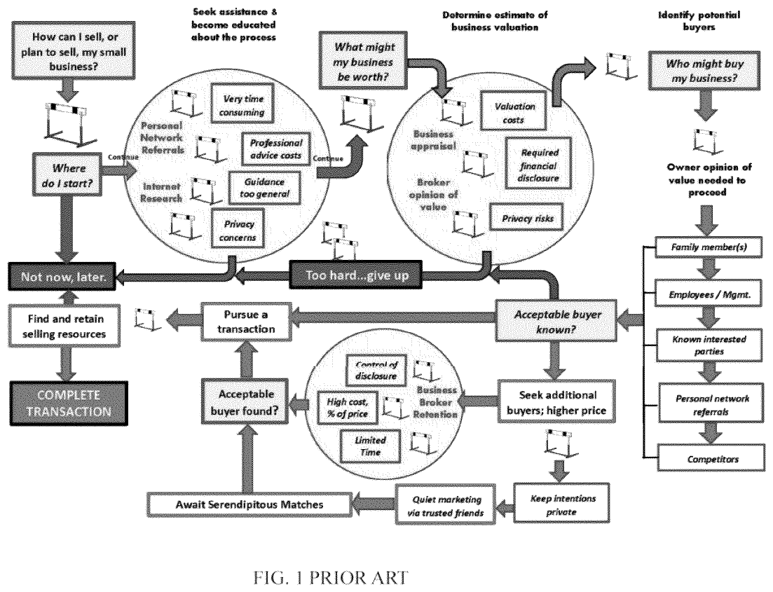

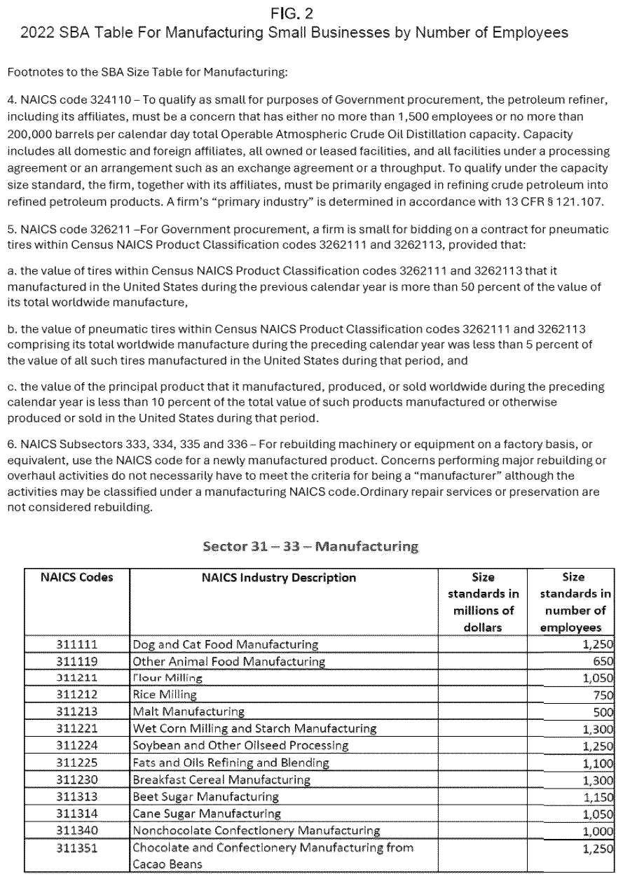

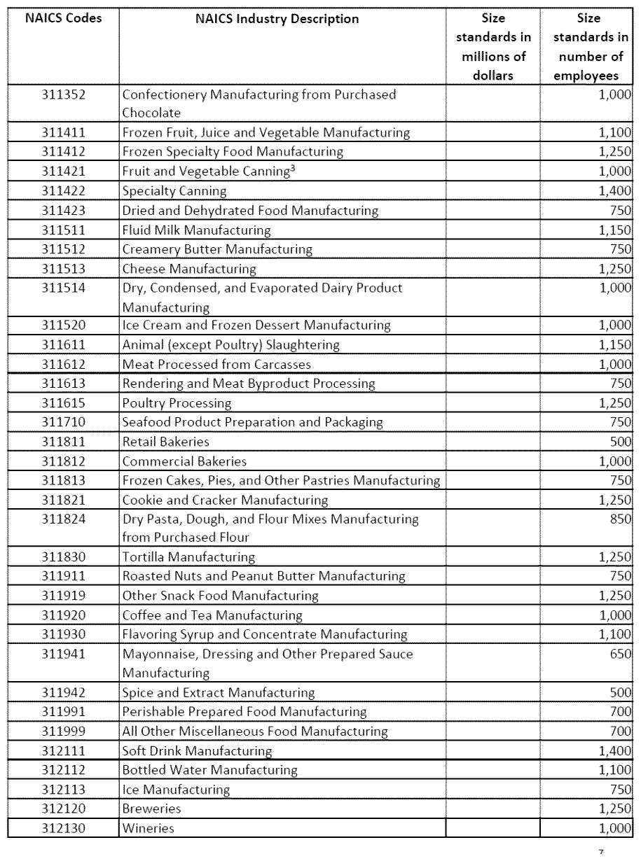

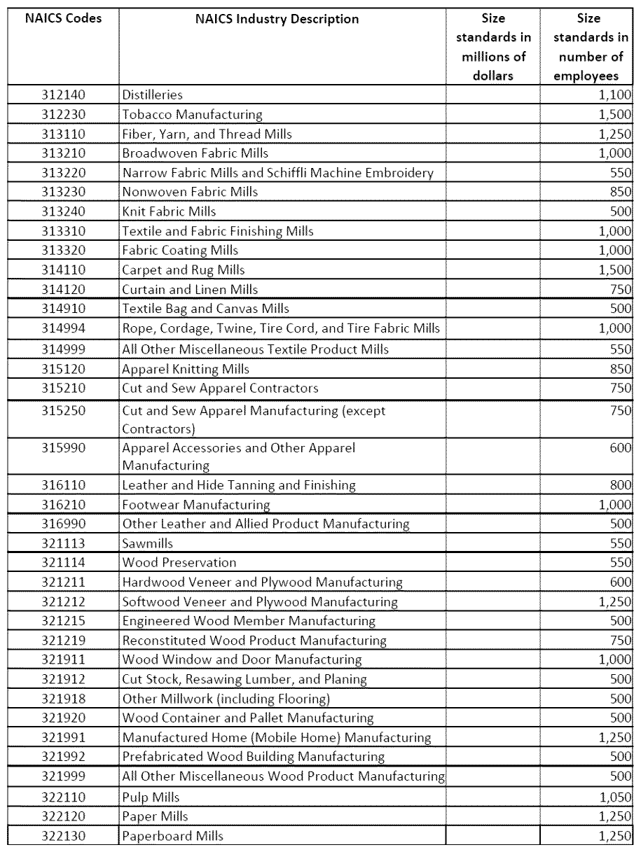

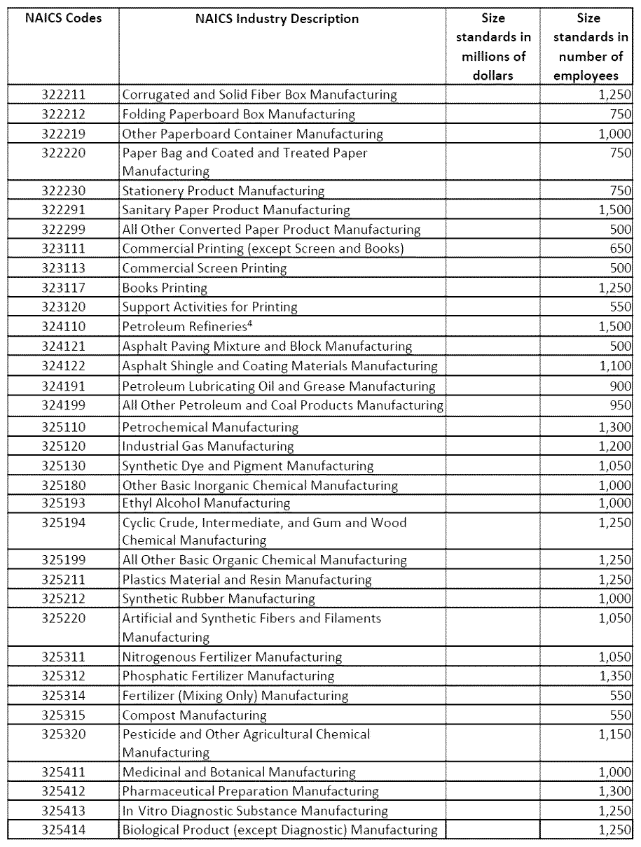

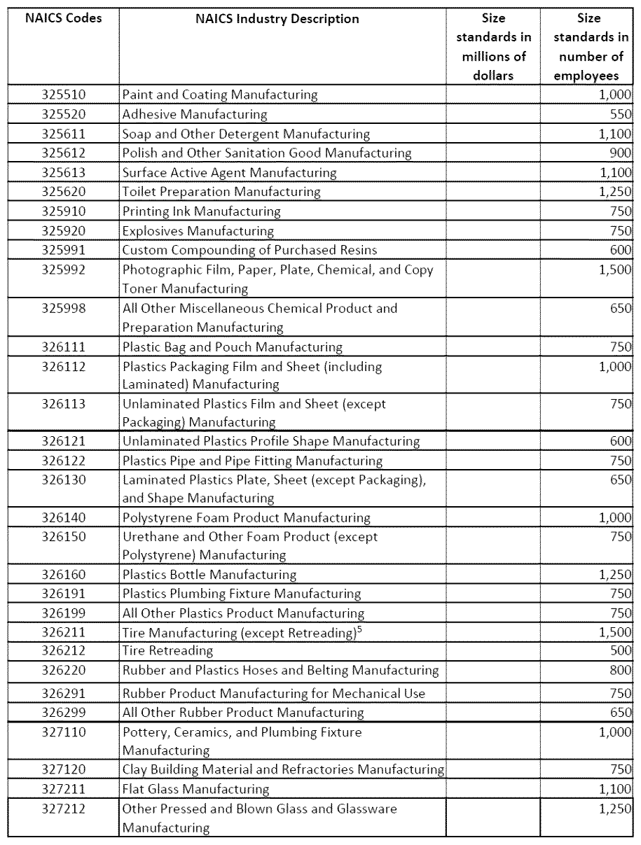

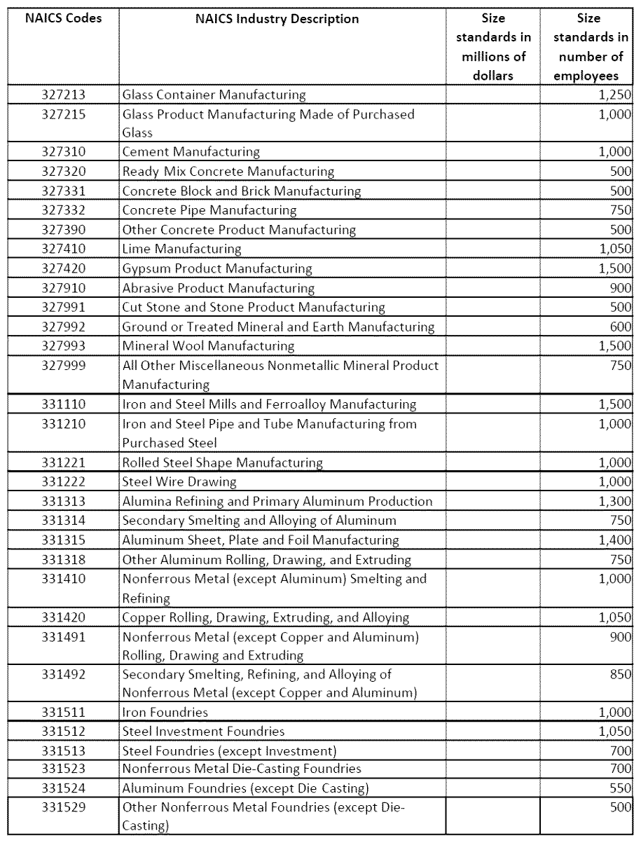

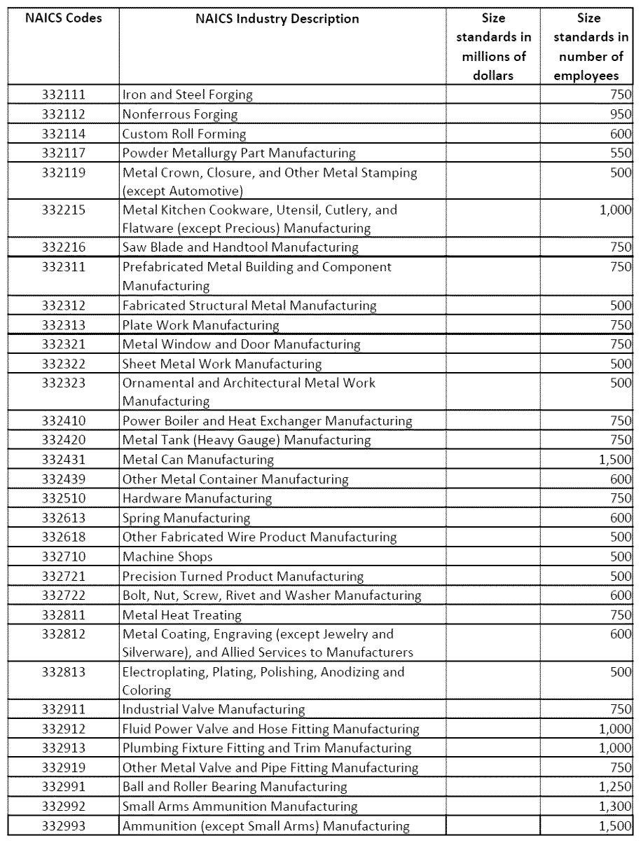

### DETAILED DESCRIPTION OF THE DISCLOSURE

This disclosure includes examples and references of exemplary embodiments for the purposes of disclosure and is not intended to limit the scope of the system and methods disclosed herein. Hereinafter, exemplary embodiments of the present disclosure will be described in detail with reference to the accompanying drawings. The examples of the methods and systems discussed herein are not limited in application to the details of construction and the arrangement of components set forth in the following description or illustrated in the accompanying drawings. It will be understood to one of skill in the art that the methods and systems are capable of implementation in other embodiments and of being practiced or of being carried out in various ways.

Various embodiments are described below with reference to block diagrams and/or flowchart illustrations of methods and systems. Each block of the block diagrams and flowchart illustrations, and combinations of blocks in the block diagrams and flowchart illustrations, respectively, can be implemented by a computer executing computer program instructions. These computer program instructions may be loaded onto a general-purpose computer special purpose computer, or other programmable data processing apparatus, such that the instructions which execute on the computer or other programmable data processing apparatus to implement the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions. It should also be understood that each block of the block diagrams and flowchart illustrations, and combinations of blocks in the block diagrams and flowchart illustrations, are not limited to the order in which they are presented.

These computer program instructions may also be stored in a computer-readable memory that can direct a computer or other programmable data processing apparatus to function in a particular manner. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. The computer program instructions may also be stored on a carrier medium or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

Illustrative embodiments provide a computer-implemented system and method for collecting data, providing a communications gateway, generating evaluations of privately held small businesses through an online platform marketplace that aids and supports the purchase and sale and succession planning of the privately owned small business.

The disclosed method and system provide a cohesive structure that eliminates the fragmentation that has historically been present due to the vast and varied nature of both the small businesses and their support ecosystem and provides more transparent visibility to the information needed to effectuate an evaluation and sale of the small business. Illustrative embodiments do this by overcoming privacy concerns by respecting the owner's concerns to provide greater visibility to the pertinent data and information needed to mitigate the historic void on pricing between a buyer and seller. The privacy constraints can be two-fold: the privacy of selling intentions due to the business owner's fears of adverse business impacts resulting from disclosure; and the privacy of company financial information and other business attributes which have no public reporting requirements. These constraints make estimating the values of private small businesses exceedingly difficult, and result in the lack of a starting point for a pricing guidance for market participants.

Illustrative embodiments frame the rules for market participation and design the underlying infrastructure, interaction, and transaction tools for a marketplace to successfully fulfill the valuation and sale of small, privately owned businesses by facilitating the sale of a private small business through the associated phases that may include: Phase 1, or the Discovery phase where the seller and buyer (or “parties”) can discover each other and communicate pertinent information in a safe and private manner; Phase 2, or the Agreement phase where the parties present and then agree on price and terms; and Phase 3, or the Execution phase: when the parties execute their agreement with an exchange of some type of consideration between the parties culminating in the sale of the privately held small business.

In the discovery phase, owner privacy concerns and a lack of pricing guidance can result in roadblocks that dramatically limits the number of potential sale transactions from reaching the agreement phase. This can lead not only to transactions that fail to materialize, but also to business sales that occur on sub-optimal terms, to the detriment of the private small business owners.

The present disclosure brings together market participants in a functioning marketplace focused on the needs and concerns of the private small business owner. To that end, illustrative embodiments of a marketplace according to the present disclosure may include a “hard” digital infrastructure component and a “soft” data and information component. The hard infrastructure may include a digital, i.e., online, platform marketplace that houses the market participants and allows them to interact with each other in a secure, private, and confidential manner.

The soft data and information component includes a suite of information including processing, transaction tracking and communication management tools, and a set of rules for use by market participants to engage securely, privately, and confidentially in the market activities including, among other things, searching, planning, and communicating. The information processing tool notably includes a business valuation estimating tool and methodology that enables consistent and comprehensive pricing guidance to market participants. In various embodiments, the digital marketplace platform may include three groups of participants, for example private, small business owners, potential buyers and/or investors, as well as advisors and other service providers.

Illustrative embodiments have features that facilitate the design of a functioning market that may include a searchable company profile for each small business together with an estimate of enterprise value, a customized small business enterprise value estimating tool, and a privacy-focused communication design.

A searchable company profile with estimated enterprise value is the product of a set of activities that involve gathering, verifying, and displaying comprehensive key details about each private small business that is determined from time to time to be relevant and meaningful to the process of discovery for both the business owner and potential investor/buyer. Key business information details are gathered from public sources and supplemented with an estimate of enterprise value for each business that is derived by the present disclosure's methodology.

The business owner is provided tools to privately verify various elements of the information to improve the quality of the information and to determine its own estimate of enterprise value. The owner's private engagement tool therefore preferably improves information quality to then enable mutual discovery of market participants to occur in a cost effective and time efficient manner so business sale transactions may more seamlessly occur.

The private nature and unique characteristics of individual private small businesses makes the assessment of an enterprise's worth exceedingly challenging. In addition, “sale comp” information is kept private, and most completed transactions are not the result of fully marketed efforts such as would be typical for a real estate transaction-where multiple prospective buyers (and readily available data) help set a clearer “market value.” However, any potential sale transaction still needs an asking price or at least an estimate of value to initiate interest or discussions. Other than openly marketed sale listings, broker opinions of value or owner-commissioned business appraisals, such estimates of value rarely exist today for small private businesses.

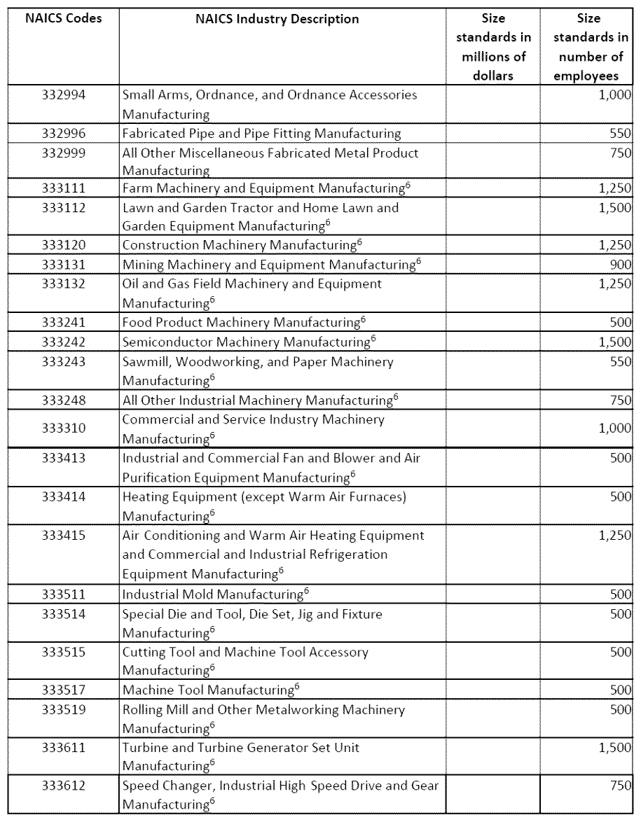

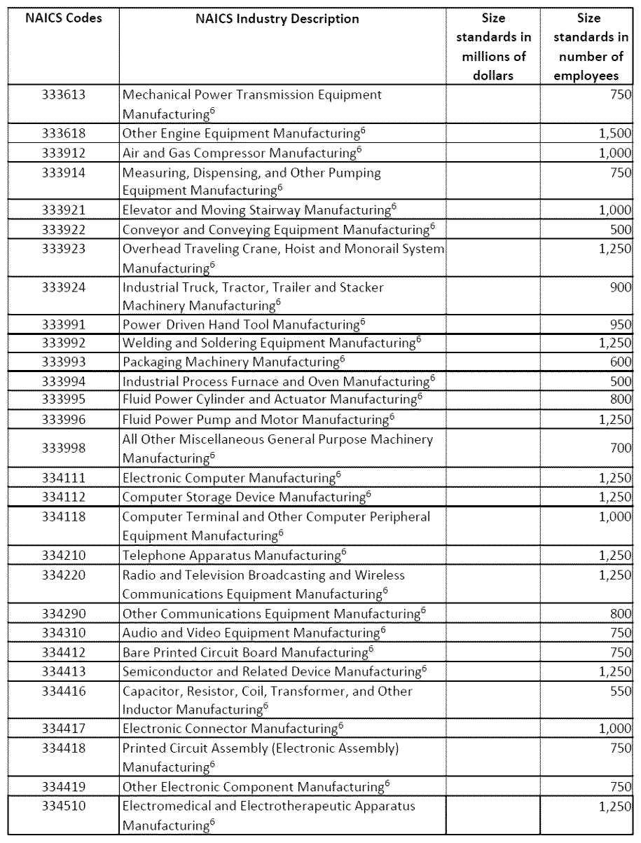

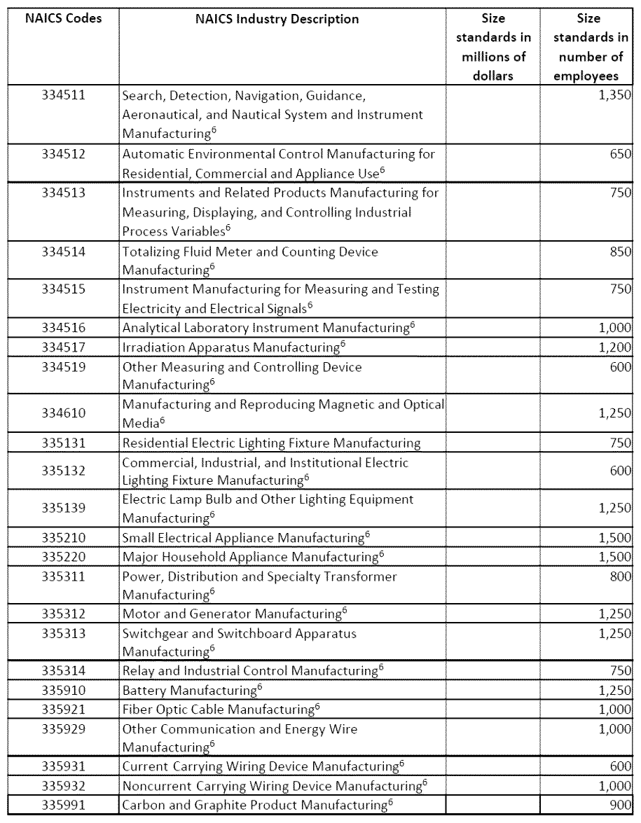

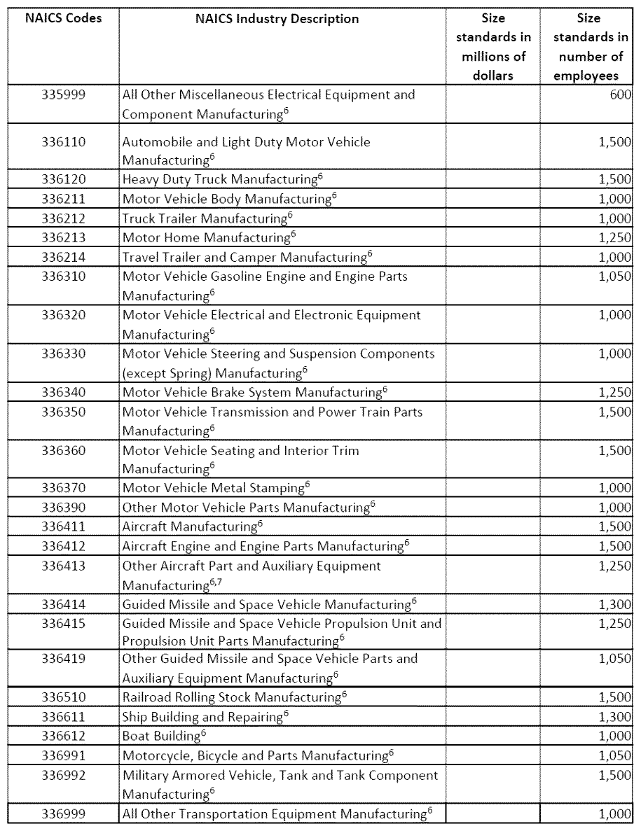

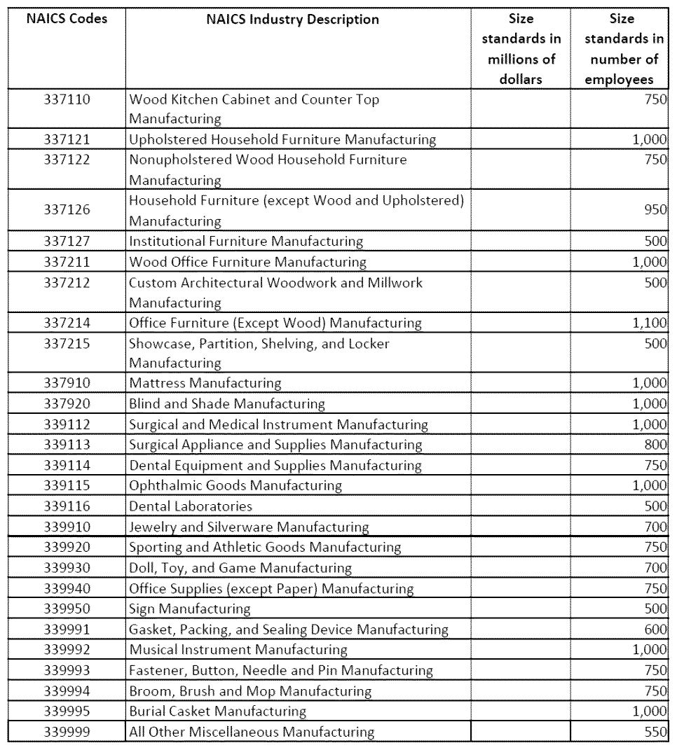

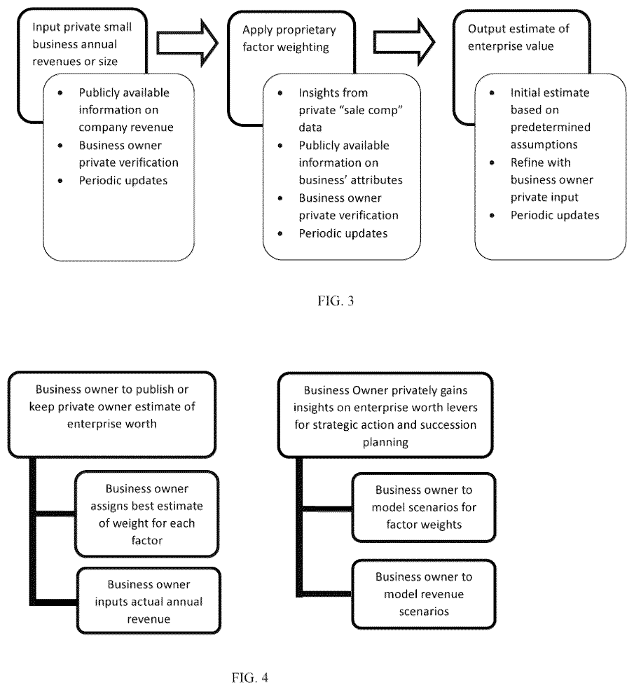

To solve this challenge, illustrative embodiments present an estimated enterprise value for each private small business using a prescribed enterprise value modeling method as illustrated in FIG. 3. In this exemplary embodiment the valuation method relies on factor-weighting of a set number of primary drivers of a company's value, starting with public and private data (and subjective assumptions made using such data) without conveying any owner-provided private data or the underlying assumptions and analysis. Illustrative embodiments preferably use statistical tools yielding a predicted value, given the inputs.

Illustrative embodiments of the methodology deploy statistical tools such as interpolation, extrapolation, multi-variable regression, measures of central tendency and dispersion on private and, if and where available, public data and data sets, of comparable sale transactions by industry/sub-industry, to gain insights, to then determine the key, discrete and statistically significant factors that when aggregated together can generate an estimate of enterprise value. In some cases, valuation assumptions, including revenue, will not be validated by the business owners and estimated values may diverge materially from those that would be determined with validated inputs. However, such estimates may still be published (and are available for updating upon owner validation at any time) for the benefit of the marketplace and the lack of better estimates available to prospective buyers. Below is an exemplary process:

Step 1—Determine and establish value factors by industry/sub-industry: Among other things, factors may include physical assets such as machinery in industries such as manufacturing and intangible assets such as patents and technology in industries/sub-industries with high incidence of intellectual property. A further embodiment of the value estimation methodology is the creation of “proxy drivers,” which are statistically shown to closely approximate the attributed value of difficult-to-evaluate intangible value drivers such as a company's “goodwill.”

Step 2—Determine company size (revenues or use of other data such as number of employees to assist estimation of revenues) and business' industry/sub-industry without owner input. Revenue data or estimates are gathered from various public and paid private sources and used as the initial anchor for estimating the enterprise value.

Step 3—Choose a numerical value from an ascending scale/range of 1-5 for each factor based on the valuer's best judgment and/or based upon public and private information that is available for use. Each numerical value when chosen displays a range of dollar values where the factor is measurable and assignable in dollar terms, and/or a range of percentages or a cardinal rank with one being the lowest 20% and 5 being the highest 20%. Those skilled in the art may use other numerical values, or even qualitative methods. Indeed, discussion of cardinal values, percentages, dollars, etc. are exemplary and not intended to limit all embodiments.

For certain factors, each number on the ascending scale may represent a dollar range that is derived for the said factor as a function of revenue. This is derived from the proportion of sales price allocated to the said factor for each comparable sale for a set number of comparable sales by industry/sub-industry. These derived proportions are then divided into quantile ranges, such as quintiles or 20% increments. The bottom 20% represents the lowest allocation of sales price to the said factor. The display under the numerical scale of “1” has a lower bound for the dollar range set to the lowest value of the data set for said factor and the upper bound set to the highest value of the lowest quintile proportion of said factor multiplied by the revenues in step 2. And the top 20% represent the highest allocation of sales price to the said factor and are displayed under the numerical scale “5” using the same method.

Certain factors are represented on the numerical scale as a range of percentages or a cardinal rank. For some factors, such as the aforementioned “proxy drivers,” the choice of a numerical scale assigns a dollar value based on a pre-assigned weight applied to revenue to approximate the valuation increase or decrease attributable to these factors. Note that quantiles may have equal ranges (e.g., as in the examples above), or in other embodiments, the quantiles may be unequal (e.g., one range 0-19.8, a second range 19.9-40.0, and a third range from 40.1-100) or based upon a different statistical measure such as standard deviation.

Step 4: The underlying dollar values from each of these numerical choices are applied to an algorithm to then derive an estimate of enterprise value. The value estimator can select one of the five choices, or the valuation algorithm can automatically select one of the five choices as a default (e.g., answer three as it is in the middle) as a starting point which is then subject to fine tuning based upon subsequently learned, or otherwise assumed information.

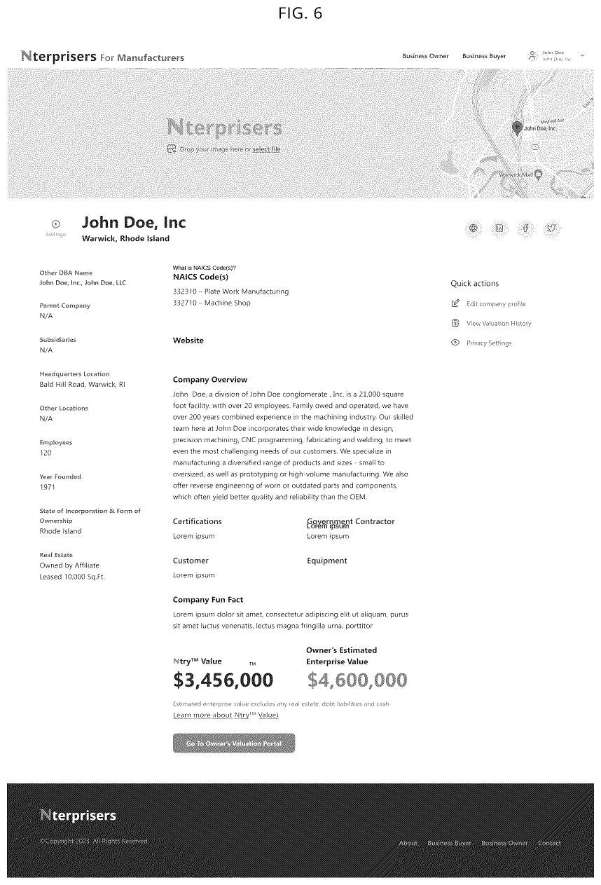

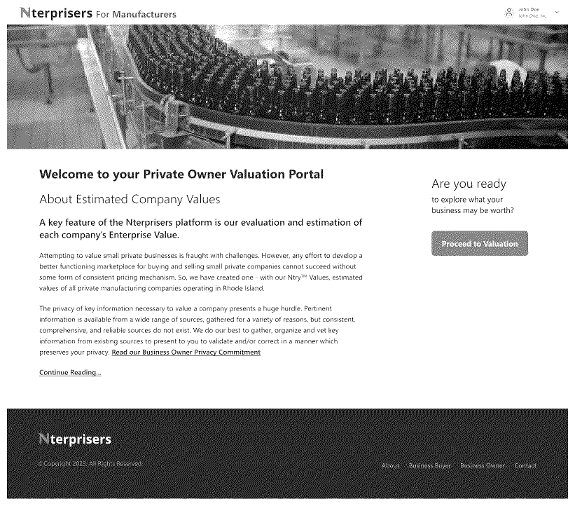

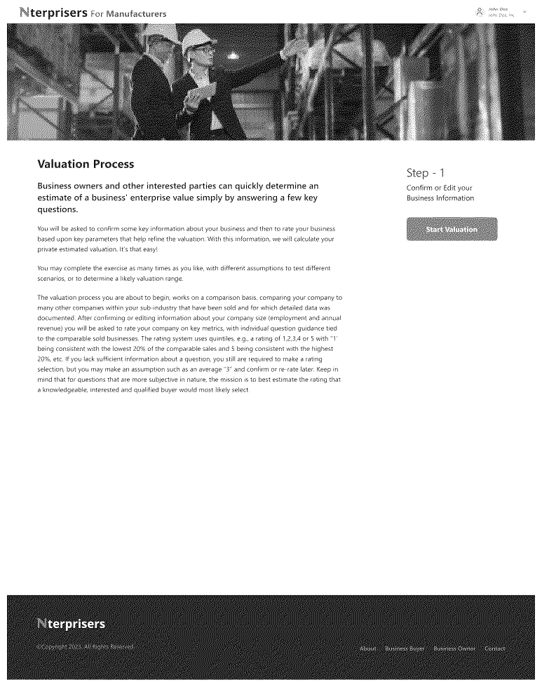

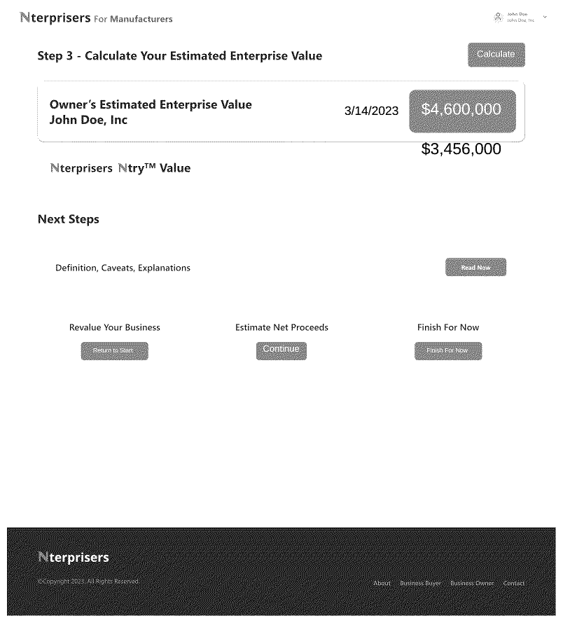

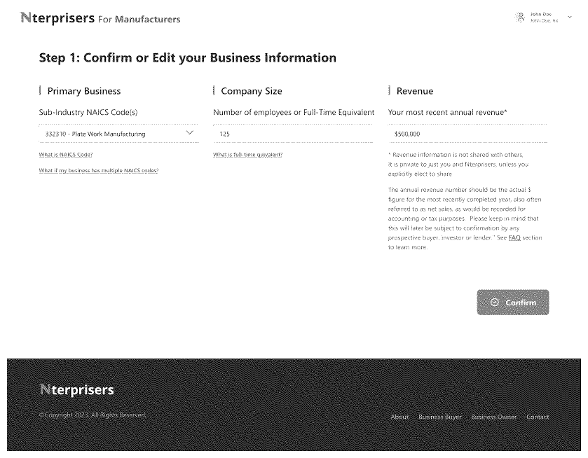

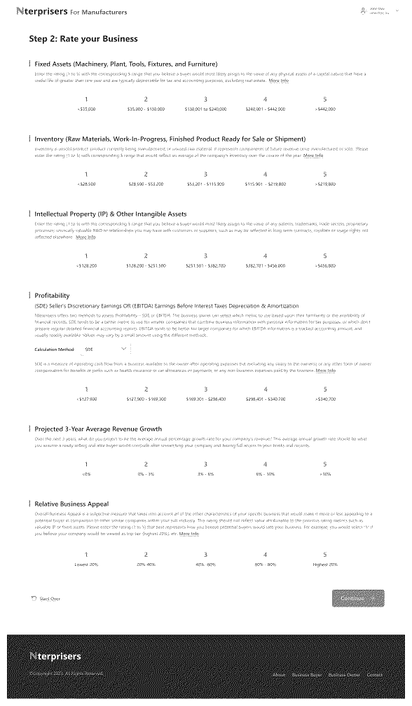

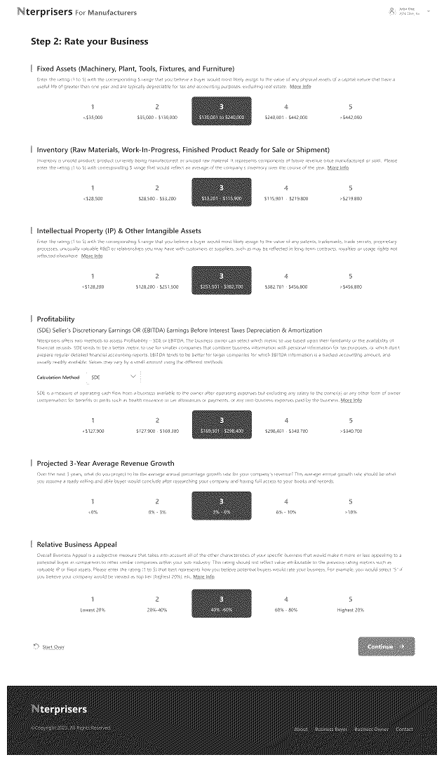

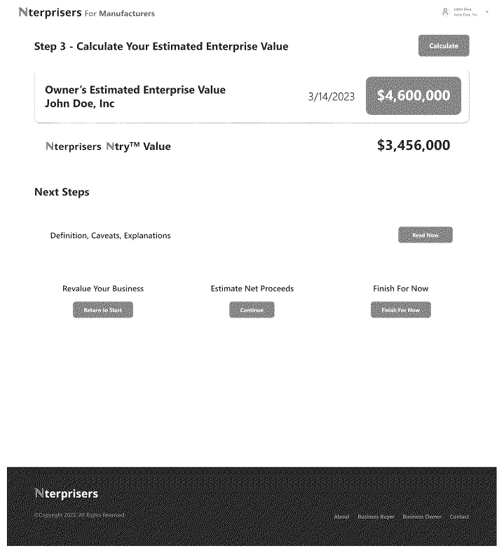

The overall valuation methodology of illustrative embodiments is also available for market participants to estimate the value of a business, or a likely range of value, which is superior to other available simple estimating methods. The design of the platform, to preserve the privacy of an owner's financial information and its other benefits, encourages each owner to confirm or correct the annual revenue that has been ascertained from public sources or by its own estimating. The revenue estimate of each business is not viewable by any of the other market participants other than the registered owner(s) of each said business. Further, the platform design will enable each owner to privately provide its own answers to the prescribed questions for each value driver (“factor weighting”) to determine its own estimate of value, which each owner may elect to present on its Company Page (see example in FIG. 6) in addition to the platform's estimated value or may keep private at the business owner's discretion. Together, these methodology embodiments yield an innovative process that enables the verification of vital private financial data and its use in determining an estimated enterprise value without sharing any of the underlying private financial data with other market participants. Prospective buyers, and other registered users will not have access to information shared by each owner, unless the owner desires to share.

The values derived from the above valuation process are presented in a consistent manner, to certain market participants allowed by the platform's access rules and such values provide starting guidance for pricing, not currently available. For example, the value estimation tool may involve confirming company size (revenue or number of employees) and then asking questions of the user who can select an answer or enter one of their own. For example, a question may ask, “for your business, is the value of your machinery: 1. Less than $50,000, 2. $50,001 to $90,000, 3. $90,001 to $135,000 4. $135,001 to $195,000, or 5. Greater than $195,000, with each dollar interval derived statistically from comparable sales transaction data using The present disclosures' valuation quantile methodology and using the company's annual revenue, for which confirmation is also sought.

This quantile information enables a market participant to select the appropriate quantile for each driver of a given company, by the statistically identified dollar range, or more simply by the assumed quantile, e.g., top 20%, in comparison to all documented comparable transactions. For example, a participant may select an “average” quantile of “3” (3 out of five representing the middle 20%) for the value of a specific company's machinery/equipment with a corresponding dollar range of say $160,000 to $240,000 (the dollar values being determined from the comp quantile ratios multiplied by the annual revenue of the company being evaluated). The market participant might know the approximate value of the business' machinery and select the corresponding quantile accordingly. Or the participant may “scenario test,” trying various quantile values to determine what a buyer would most likely conclude. The quantile embodiment of the present disclosures' methodology enables a market participant without private knowledge to still create an enterprise value estimate using their best guess quantile ranges, or scenario testing to develop a likely range of estimated value as illustrated in FIG. 4.

Although estimates of value are carefully vetted individually using the best information available through public and private sources, only the owner of each business may know the accuracy of some key metrics. Accordingly, each business owner is afforded the chance, in multiple ways, to improve the platform's data quality and enterprise worth as well as the opportunity to reflect their own opinion of enterprise worth, in a manner that protects the owner's privacy. This owner engagement step allows for verification of some or all company information and improves overall information quality and visibility for all market participants. Verification may also entail asking the owner to answer a series of questions relating to valuation assumptions with prescribed choices for answers. This quantile methodology embodiment addresses one of the most significant sources of friction for market participants seeking initial estimates of small business values, who very often give up when not in possession of the detailed financial and other company information traditionally required by business appraisers and other valuation professionals. This initial guidance serves as a rough estimate for small business enterprise value and helps to reduce time and cost of search.

It is understood that established companies may not want to publicly market their company for sale for fear of adverse impacts to business relationships and employees. Illustrative embodiments facilitate a discovery process that emphasizes owner privacy.

Illustrative embodiments of the platform also provide a consistent and comprehensive resource for information regarding private small businesses within a defined geography, making it the ideal starting point for most business acquisition investigations. This improved visibility should translate to speedier and mutually beneficial business sale transactions and increased market liquidity

Prospective Buyers and investors can search for businesses by various search terms. They can easily sort and compare this verified information and reduce the cost, time and risk involved in decision making necessary to initiate an inquiry of interest to acquire a business. The platform may be configured to show certain types and amounts of data to the prospective buyers and investors. Different levels of access in a subscription model (e.g., buyer side, owner side, or advisor/service provider side) may additionally dictate the information shown for a given business.

The illustrative simplified interactive and proprietary valuation tool helps private small business owners gain understanding of the key drivers to their business enterprise value and attractiveness to successors without relying on detailed accounting and hard to obtain financial information.

The platform preferably will provide a curated library of resources and referrals to start succession planning. The platform also may provide other ancillary services to reduce transaction friction. Over time, this may include listings for sale at the discovery phase and a variety of streamlined service enhancements or “pre-packaged” documentation offerings for the execution phase of a transaction. These resources preferably are accessible to registered users based on their subscription privileges. Inclusion on the platform alongside all other companies in the same industry/region provides market credibility and engenders trust. More local entrepreneurs, who have run and often founded these local businesses, will be awarded for their risk-taking and local community commitment due to increased opportunities to sell.

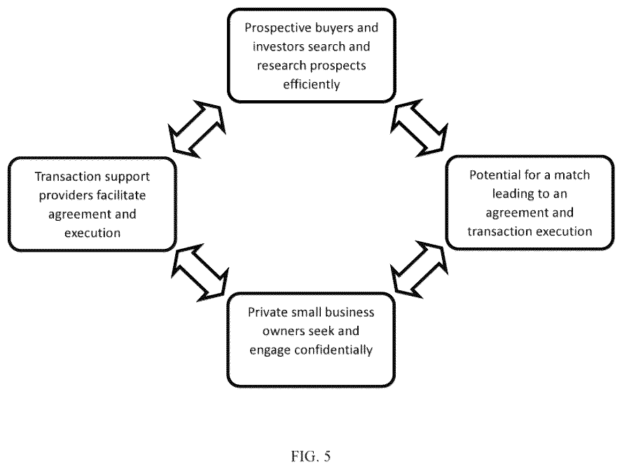

In addition to the foregoing, as illustrated in FIG. 5, buyer matching is enabled without the need for disclosure of an owner's selling intentions or its private financial information. Illustrative embodiments improve price discovery by aggregating and curating the comprehensive domain of salient information on private small businesses and valuing each, allowing for meaningful comparisons. To that end, the platform may be utilized as a new marketing channel for promoting small businesses to investors, lenders, potential employees, and suppliers, in addition to potential business acquirers. More local businesses will be afforded the opportunity to sell to a wider range of future owners who seek to continue these businesses and grow them locally. The platform can serve as a practical new entry point to business ownership for a wide range of individuals, including those who may not have considered becoming a business owner, and those who have been practically excluded due to lack of personal network connections to these historically closed transaction markets.

Accordingly, illustrative embodiments of the platform and/or the marketplace and market activities are developed with an aim to one or more of the following beneficial results: 1.) reduce uncertainty in quality of information needed to engage in the purchase and sale of, and/or succession and business continuity planning or any business ownership transition transaction for a private small business, 2.) protect the privacy of the private small business owner in information sharing, and transaction execution, 3.) reduce the uncertainty in and cost for consummating a business sale transaction for a private small business, 4.) improve the chances for completing a successful purchase and sale of a private small business at an optimum market price and/or enable succession or business continuity planning for a private small business to improve the likelihood of a successful future ownership transfer transaction, and/or 5.) preserve quality local jobs and help local tax revenues as new small business owners invest in their acquired businesses and succeed. Illustrative embodiments therefore can create enormous socio-economic value. Of the thirty-three million private small businesses, 16.4% have between one and nineteen employees. These approximately 5.43 million businesses are surmised to have an average enterprise value of between $250,000 and $500,000, approximating about $1.5 trillion in estimated value. This platform therefore has the potential to produce outsized benefit largely to the smallest of small businesses.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various processes described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”), handheld device (e.g., a “smartphone”), or cloud computing model. Of course, some embodiments of the invention may be implemented as a combination of both software (e.g., a computer program product) and hardware. Still other embodiments of the invention are implemented as entirely hardware, or entirely software.

Those skilled in the art also may implement some processes using artificial intelligence and machine learning techniques, such as the ChatGPT API.

As will be appreciated, the method and system described herein through the illustrative embodiments respects the small business owner privacy and significantly mitigates the current void on pricing between buyers and sellers.

While the principles of various embodiments have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure and the appended claims.

In addition, it is to be understood that the phraseology and terminology used herein is for the purpose of description and should not be regarded as limiting. The use of “including,” “comprising,” “containing,” “involving,” or “having,” and variations thereof herein, is meant to encompass the items listed thereafter and equivalents thereof as well as additional items while only the terms “consisting only of” or “consisting essentially of” are to be construed in a limitative sense. References to “or” may be construed as inclusive so that any terms described using “or” may indicate any of a single, more than one, and all of the described terms.

What is claimed is:

1. A method for estimating the enterprise value of a privately held company, the method comprising:
producing an initial estimate of enterprise value of the company based on public data;
developing a proprietary, statistically based valuation methodology to estimate enterprise values of private small businesses by industry/sub-industry;
providing certain privacy and confidentiality rights to business owners to encourage owner validation and editing of private company information important to the quality of the estimated values;
employing a quantile user interface methodology which enables users without full access to private data to estimate the value of an identified business;
providing secure access to identified business owner to access, verify or correct their number of employees, annual revenue, and industry/sub-industry (NAICS code) and view their estimate of enterprise value;
providing, via a user interface, a set of prescribed questions, each question having a plurality of prescribed answers, the plurality of prescribed answers being related to the company's assets, financial performance, geography, industry, and/other characteristics which add or detract from the company's estimated enterprise value;
receiving prescribed answers from the plurality of answers to each question;
modifying the initial estimate as a function of the received at least one prescribed answers to produce a modified estimate;
publishing the modified estimate in response to a request to publish the modified estimate; and
providing access to estimated values by prospective buyers or other authorized registrants and enabling such users to independently estimate business values using a valuation process and user interface similar to that provided to business owners as described above.

2. The method of claim 1 wherein publishing comprises publishing the modified estimate without publishing the received prescribed answers.

3. The method of claim 1 further comprising storing the initial and subsequent estimates in a database and the ongoing use of such data for analysis and other business purposes, the method further comprising ongoing updating of the database.

4. A system for managing the valuation of a privately held company, the method comprising:
producing an initial valuation of the company based on public data;
receive a request to access the initial valuation;
providing, via a user interface, a set of prescribed questions, each question having a plurality of prescribed answers, the plurality of prescribed answers being related to the company geography, industry, and/or size of the company;
receiving at least one prescribed answer from the plurality of answers;
modifying the initial valuation as a function of the received at least one prescribed answer to produce a modified valuation; and
publishing the modified valuation in response to a request to publish the modified valuation.

5. The method of claim 4, wherein publishing comprises publishing the modified valuation without publishing the received at least one prescribed answer.

6. The method of claim 4 further comprising storing the initial valuation in a database.
